(19) United States
(12) Patent Application Publication
(10) Pub. No.: US 2019/0054556 A1
(43) Pub. Date: Feb. 21, 2019

(54) METHOD FOR BONDING A CYLINDER LINER WITHIN A CYLINDER BORE OF A VEHICLE ENGINE BLOCK

(71) Applicant: GM GLOBAL TECHNOLOGY OPERATIONS LLC, DETROIT, MI (US)

(72) Inventors: Huaxin Li, Rochester Hills, MI (US); Jianghuai Yang, Rochester Hills, MI (US); Dale A. Gerard, Bloomfield Hills, MI (US); Daniel J. Wilson, Linden, MI (US)

(21) Appl. No.: 15/677,045

(22) Filed: Aug. 15, 2017

(51) Int. Cl. B23K 1/002; F02F 1/00; B23K 35/28; C22C 18/04

(52) U.S. Cl. CPC B23K 1/002; F02F 1/004; F02F 7/0021; C22C 18/04; B23K 35/282

(57) ABSTRACT

A method for bonding a cylinder liner within a cylinder bore of a vehicle engine block includes providing a bonding substrate on one of an outside surface of the cylinder liner and an inside surface of a cylinder bore in the engine block, positioning the cylinder liner in the cylinder bore, and heating the cylinder liner.

### FIELD

The present disclosure relates to a method for bonding a cylinder liner within a cylinder bore of a vehicle engine block.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

During a combustion cycle of an internal combustion engine (ICE), air/fuel mixtures are provided to cylinders within an engine block of the ICE. The air/fuel mixtures are compressed and/or ignited and combusted to provide output torque via pistons positioned within the cylinders. As the pistons move within the cylinders, friction between the piston and cylinder and the presence of fuel can wear and degrade the cylinder surfaces. Additionally, combustion pressure and piston side loading can pose a significant amount of stress on the cylinder bores.

Historically, ICEs have employed cylinder liners to prevent wear or damage to the engine block. Especially when the engine block is formed from an aluminum alloy, which may be a much lighter material, but which may have poor wear resistance. Cylinder liners have been made of various grades of cast iron (e.g., gray iron). Cast iron is selected, in part, for its low production cost, ease of manufacture, satisfactory thermal conductivity, which minimizes bore distortion, and good wear resistance due to the presence of free graphite which acts as a lubricant and reduces friction with the piston ring pack. Unfortunately, gray iron materials may impart significant undesired weight to an engine block, due to their high densities (e.g., >7.1 g/cm³) and high wall thicknesses (e.g., about 2 to 4 mm) which are needed to compensate for poor mechanical properties (e.g., low strength and low modulus of elasticity). High wall thicknesses increase the weight of the engine and can reduce overall vehicle fuel efficiency. Further, gray iron cylinder liners may be susceptible to cracking during service, in part due to the residual stress that may be inherited from the casting process.

Conventionally, a cast iron (or gray iron) cylinder liner may be placed into an engine block mold and the block material may then be cast around the liner. A liner which has been incorporated into an engine block in this manner may be referred to as a cast-in-place cylinder liner. The bonding between the cylinder liner and the engine block may be deficient. Poor bonding may result in reduced heat transfer between the liner and the block, a distortion of the cylinder bore, reduced stiffness, and even structural failure such as, for example, cracks developing in the liners and/or engine block material. Additionally, although switching from an entirely cast iron engine block to an aluminum engine block having a cast iron cylinder liner results in a significant weight reduction, additional weight savings may be obtained by using a different liner material, such as, for example, a steel alloy.

A steel cylinder liner may also be provided to an engine block through other processes. One exemplary process is referred to as a “press-in-place” process in which an aluminum alloy engine block is prepared having cylinder bores and a steel cylinder liner is pressed into or pushed into the cylinder bore. Pressed-in-place steel cylinder liners also suffer from deficiencies due to inadequate bonding which are similar to those described previously in reference to iron liners. In some instances, a portion of the outer surface of the steel cylinder liner may not contact the material of the engine block resulting in a gap between the two surfaces. Any gap between the liner and the block may cause multiple problems, such as, for example, low heat transfer, low stiffness, uncontained combustion (also known as “blow by”), and the like.

Thermal spray steel cylinder bores have been identified as an alternative to gray iron cylinder lines, particularly due to the weight saving advantages provided by the ability to have a much thinner wall thicknesses which are possible when using steel rather than iron. However, manufacturing thermal spray bores may be complex and require expensive materials and equipment.

It has remained challenging to create and maintain strong adhesion of a sprayed steel coating to an engine block substrate which usually comprises a cast Aluminum alloy. A special bore surface activation process is required to enhance the coating's adhesion to the matrix. Moreover, the sprayed steel coating is hard and brittle as a result of the process and subsequent manufacturing cost may be excessive. It has further recently been found that an ultra-thin sprayed coating steel liner may cause cylinder bore thermal management issues due to too much thermal loss of the thin liner.

It is desirable to provide a cylinder liner that is sufficiently adhered or bonded to the cylinder bore engine block substrate which results in a desired heat transfer and cylinder integrity having reduced wear, reduced distortion and reduction or prevention of cracking or other failures.

### SUMMARY

In an exemplary aspect, a method for bonding a cylinder liner within a cylinder bore of a vehicle engine block includes providing a bonding substrate on one of an outside surface of the cylinder liner and an inside surface of a cylinder bore in the engine block, positioning the cylinder liner in the cylinder bore, and heating the cylinder liner.

In another exemplary aspect, the bonding substrate substantially melts during the applying of heat to the cylinder liner.

In another exemplary aspect, the method further includes cooling the cylinder liner and the bonding substrate forms an intermetallic bond with the cylinder liner during the cooling.

In another exemplary aspect, the method further includes cooling the cylinder liner and the bonding substrate forms an intermetallic bond with the cylinder bore of the engine block during the cooling.

In another exemplary aspect, heating the cylinder liner comprises induction heating the cylinder liner.

In another exemplary aspect, the method further includes positioning an induction heater within the cylinder bore before induction heating the cylinder liner.

In another exemplary aspect, the bonding substrate includes an alloy of at least one of Zinc, Aluminum, Iron, Nickel, and Copper.

In another exemplary aspect, cylinder liner includes a steel alloy and the engine block includes an aluminum alloy.

In another exemplary aspect, the cylinder liner includes an iron alloy and the engine block includes an aluminum alloy.

In another exemplary aspect, the bonding substrate includes a filler material having a lower melting temperature than the cylinder liner and the engine block and heating the cylinder liner causes the filler material to melt and form a metallurgical bond between the cylinder liner and the engine block in a brazing operation.

In another exemplary aspect, positioning the cylinder liner includes pressing the cylinder liner in place within the cylinder bore.

In another exemplary aspect, the method further includes machining an internal surface of the cylinder liner.

In another exemplary aspect, the machining includes honing an internal surface of the cylinder liner.

In this manner, a strong metallurgical bond between the cylinder liner and the cylinder bore of a vehicle engine block may be provided which has excellent thermal conductivity and strong mechanical properties. Stiffness of the cylinder liner may be significantly improved which provides dimensional stability and resistance to thermal distortion that is advantageous both for machining of the cylinder liner and during operation of the vehicle engine. Additionally, in comparison to other methods for providing a steel alloy cylinder liner, such as, for example, in a spray bore process, the advantages of a steel alloy cylinder liner, such as reduced weight improved resistance to distortion, and improved wear resistance in comparison with an iron liner, is obtained without the complexity and cost of other processes and systems.

Additionally, a steel alloy cylinder liner which is provided from a steel alloy tube which is cut to form cylinders may be used with the present disclosure which may further reduce the cost and complexity.

Further, the high strength and Young's Modulus of steel in a cylinder liner which has been bonded within the cylinder bore of a vehicle engine block in accordance with the present disclosure may provide a reduction of weight through the use of a thinner wall section for the cylinder liner in comparison with an iron cylinder liner.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic side view of a piston within an engine block cylinder bore;

FIG. 2 is a partial cross-sectional view of an interface between a cylinder liner and an engine block with a bonding substrate interposed between the cylinder liner and the engine block in accordance with an exemplary embodiment of the present disclosure;

FIG. 3 is a phase diagram for Aluminum-Zinc;

FIG. 4 is a phase diagram for Iron-Zinc; and

FIG. 5 is a flowchart of a method in accordance with an exemplary embodiment of the present disclosure.

### DETAILED DESCRIPTION

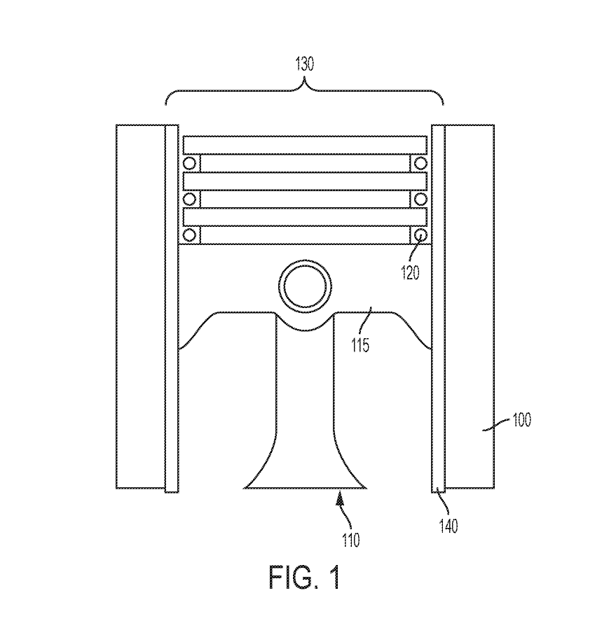

FIG. 1 illustrates a side view of a piston 110 positioned within an engine block 100 cylinder bore 130. Piston 110 includes a head 115 with one or more rings 120.

The cylinder liner 140 can be positioned within cylinder 130. During a combustion cycle of an internal combustion engine (ICE), an air/fuel mixture may be provided to cylinder 130 of the ICE. The air/fuel mixture may be compressed and/or ignited and combusted to provide output torque via the piston 110 positioned within the cylinder bore 130. The cylinder liner 140 may come in contact with one or more rings 120 and/or piston head 115, during operation of an ICE. The cylinder liner 140 may also reduce and/or prevent wear of the engine block 100 from contact with the piston 110 and/or one or more of fuel and combustion gases.

A cylinder liner formed from a steel alloy may possess advantages over conventional cylinder liners, such as gray iron liners or advanced thermal sprayed steel liners, due to increased strength and stiffness (e.g., tensile strength and Young's modulus), high compatibility with piston ring packages, and lower wear rate, physical distortion, and friction with pistons. In particular, the high strength and stiffness of a steel alloy may provides thinner, lighter cylinder liners relative to the cylinder liners formed with other materials such as, for example, gray cast Iron. In any case, any suitable material may be used for the cylinder liner such as, for example, a steel alloy, an iron alloy, or other material without limitation. In a preferred embodiment, significant advantages may be obtained by using the steel alloy that is disclosed in co-assigned, co-pending patent application Ser. No. 15/251,259 the disclosure of which is incorporated herein in its entirety.

In an exemplary embodiment of the present disclosure, an outer surface of a cylinder liner may be coated with a bonding substrate. Alternatively, the internal surface of the cylinder bore of the engine block may be coated with the bonding substrate. The bonding substrate may be made from any material which is amenable to forming a bond between the cylinder liner and the cylinder bore in the engine block. In an exemplary embodiment, the bonding substrate may be a material which has a lower melting point than either of the material forming the cylinder liner and the material forming the engine block. In this manner, after the coated cylinder liner is positioned in the cylinder bore of the engine block and subsequently heated, the bonding substrate may melt while both the engine block and cylinder liner remain in a solid phase. In this manner, the bonding substrate may serve in a manner very similar to a filler in a brazing process.

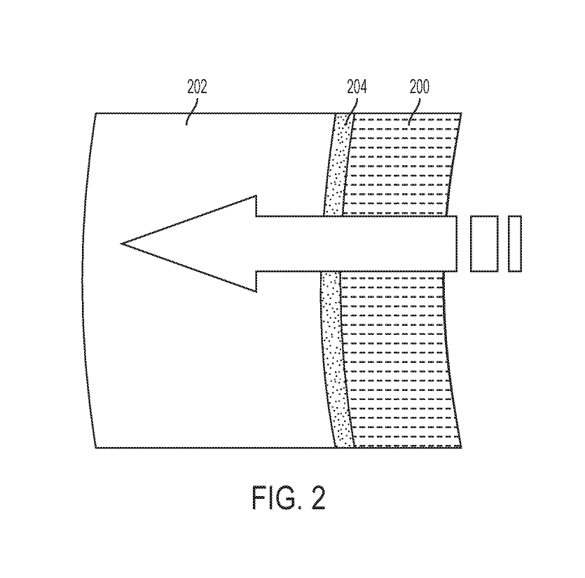

FIG. 2 illustrates a partial cross-sectional view of an interface between a cylinder liner 200 and an engine block 202 which includes a bonding substrate 204 interposed between the cylinder liner and the engine block in accordance with an exemplary embodiment of the present disclosure. As explained previously, the bonding substrate 204 may have been applied to the outer surface of the cylinder liner 200 and/or the inner surface of a cylinder bore of the engine block 202. In an exemplary embodiment, the cylinder liner 200 may be made of a steel alloy, the engine block may be made of an Aluminum alloy, and the bonding substrate may be made of an Aluminum-Zinc alloy.

In an exemplary embodiment, heat may be applied to the cylinder liner 200, bonding substrate 204, and engine block 202 in a manner which results in the bonding substrate 204 forming a bond between the cylinder liner 200 and the engine block 202.

In a preferred embodiment, heating of the bonding substrate 204 results in inter-metallics forming between the bonding substrate 204, the cylinder liner 200 and the engine block 202 which provides a strong bond. Conventionally, an intermetallic bonding has not been thought to provide a good bond because inter-metallics are generally brittle and not strong in tension. This is generally applicable in most bonding conditions. However, the cylinder liner and cylinder bore structure make it uniquely amenable to intermetallic bonding. The interface or bond between the cylinder liner and the cylinder bore is not subject to a tension stress. Rather, the interface is primarily only subject to shear stress. Intermetallic bonding provides a very good resistance to shear stress.

Further, the heating of the cylinder liner, bonding substrate, and cylinder bore may result in an expansion of the cylinder liner more than the engine block due to a difference in coefficient of thermal expansion. This difference in expansion increases the pressure applied by the cylinder liner to the inner surface cylinder bore and through the bonding substrate which further enhances the atomic diffusion and the metallurgical reaction between the layers, including inter-metallics, and further improves the bond between the cylinder liner and the cylinder bore of the engine block.

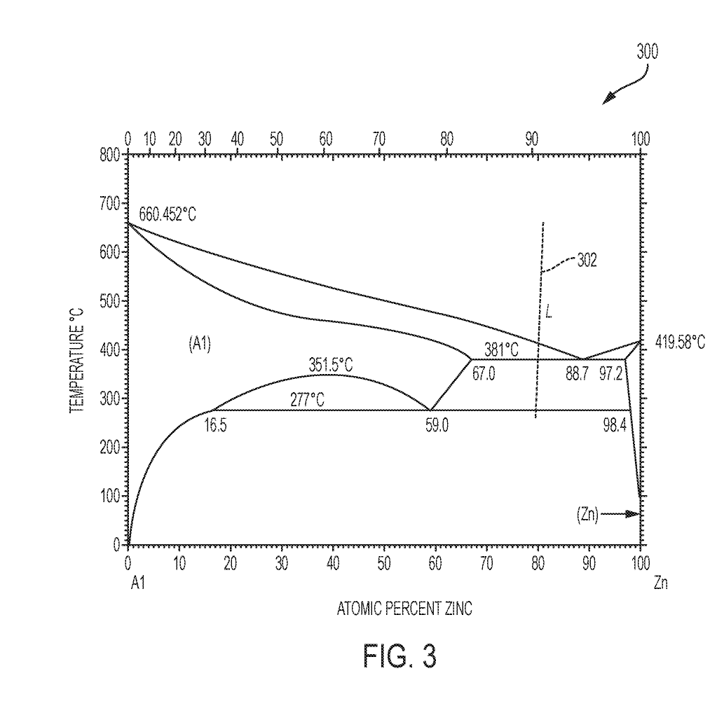

FIG. 3 illustrates a phase diagram 300 for Aluminum-Zinc. A bonding substrate having an Aluminum-Zinc composition of about 80% Zinc (by atomic weight, or about 90% Zinc by weight percent), as indicated by line 302 may have a lower melting temperature of about 430 degrees Celsius which is lower than the melting temperature of the Aluminum alloy of the engine block and the steel or iron alloy of the cylinder liner. A bonding substrate having such a composition may be used as a bonding substrate and the cylinder liner, engine block and bonding substrate may be heated to a temperature of between about 480-530 degrees Celsius to form a metallurgical bond.

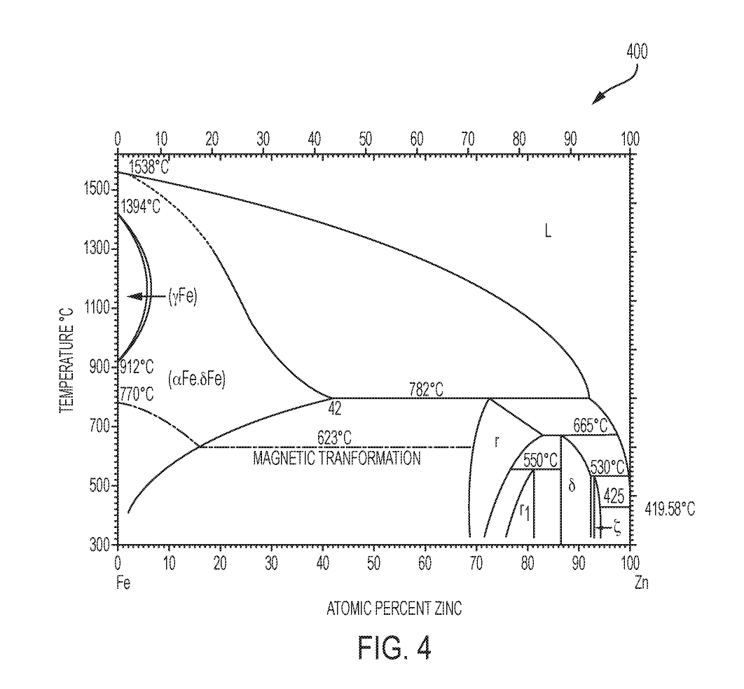

FIG. 4 illustrates a phase diagram 400 for Iron-Zinc. Similar to that described above with respect to FIG. 3, a bonding substrate having an Iron-Zinc composition may be selected which has a lower melting temperature than the cylinder liner and engine block. In this manner, the bonding substrate will melt and form a strong inter-metallic, metallurgical bond between the cylinder liner and the cylinder bore.

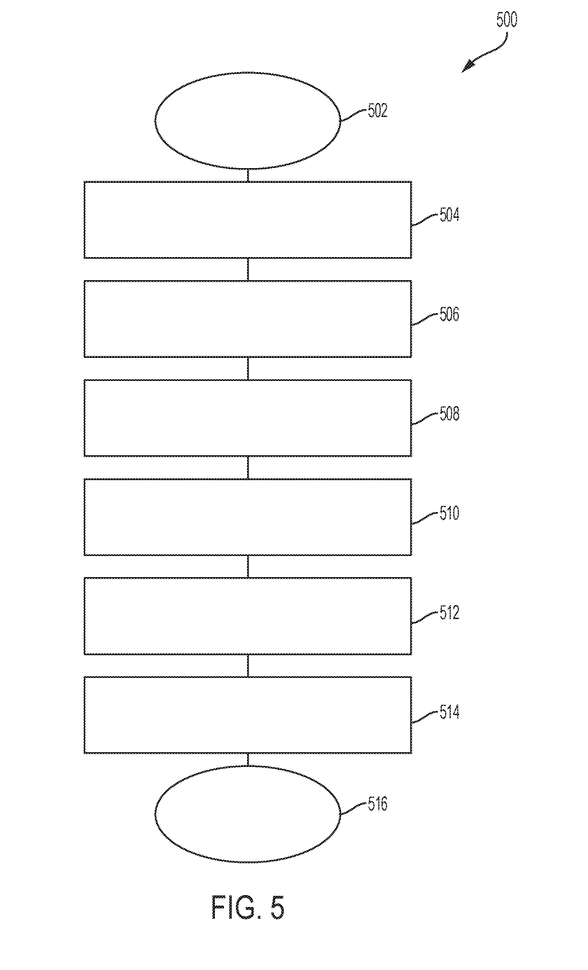

FIG. 5 is a flowchart 500 of a method in accordance with an exemplary embodiment of the present disclosure. The method starts at step 502 and continues to step 504 where a bonding substrate is applied to one or both of the outer surface of the cylinder liner and the inner surface of the cylinder bore of an engine block. The bonding substrate may be applied with any method and/or system such as, for example, a plating method, thermal spray coating, hot dipping, or the like without limitation. The method then continues to step 506 where the cylinder liner is positioned into the cylinder bore in the engine block. In an exemplary method, the liner may be positioned using a press-in-place process in which the cylinder liner is pressed into the cylinder bore. Alternatively, the temperature of the cylinder liner may be reduced to permit the cylinder liner to shrink sufficiently to permit the cylinder liner to be positioned within the cylinder bore without an interference fit.

The method then continues to step 508 where an induction heater is positioned within the cylinder liner and the method continues to step 510. In step 510, the induction heater induction heats the cylinder liner to a temperature which is preferably sufficient to melt the bonding substrate without melting either the cylinder liner and/or the cylinder bore of the engine block. As the cylinder liner increases in temperature, heat is transferred from the cylinder liner into the bonding substrate and further into the cylinder bore surrounding the substrate. In this manner, the bonding substrate melts and experiences a pressure due to the thermal expansion of the liner which causes the bonding substrate to form a metallurgical bond between the cylinder liner and the cylinder bore, preferably including inter-metallics. The method then continues where the induction heater is removed in step 512, and the cylinder liner, bonding substrate, and engine block cools in step 514 to solidify the metallurgical bond between the cylinder liner and the cylinder bore. The method then ends in step 516.

In another exemplary embodiment of a method in accordance with the present disclosure the inner surface of the cylinder liner may be machined. The properties which result from the present disclosure improves the ability to finish the inner surface of the cylinder liner. For example, the inner surface of the cylinder liner may be honed and the improved characteristics may reduce and/or eliminate distortions of the cylinder liner which otherwise might interfere with the honing process. The qualities of the inner surface of the cylinder liner which results from an improved capability to surface machine may reduce friction and wear during operation of the vehicle engine.

The present method and disclosure may also permit the use of a surface feature on an outer surface of the cylinder liner to which the bonding substrate is applied. In this manner, the structural and mechanical bond between the cylinder liner and the cylinder bore of the vehicle engine block may be further enhanced.

As explained previously, the high strength and Young's Modulus of steel in a cylinder liner which has been bonded within the cylinder bore of a vehicle engine block in accordance with the present disclosure may provide a reduction of weight through the use of a thinner wall section for the cylinder liner in comparison with an iron cylinder liner. For example, in comparison with an iron cylinder liner having a wall thickness of about 1.5 millimeters, a steel cylinder liner having a thinner wall thickness of between about 0.75 and 1.0 millimeters may be enabled through use of an exemplary embodiment of the present disclosure. This results in a weight savings of between about 25-50%.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for bonding a cylinder liner within a cylinder bore of a vehicle engine block, the method comprising:
providing a bonding substrate on one of an outside surface of the cylinder liner and an inside surface of a cylinder bore in the engine block;
positioning the cylinder liner in the cylinder bore; and
heating the cylinder liner.

2. The method of claim 1, wherein the bonding substrate substantially melts during the applying of heat to the cylinder liner.

3. The method of claim 2, further comprising cooling the cylinder liner and wherein the bonding substrate forms an intermetallic bond with the cylinder liner during the cooling.

4. The method of claim 2, further comprising cooling the cylinder liner and wherein the bonding substrate forms an intermetallic bond with the cylinder bore of the engine block during the cooling.

5. The method of claim 1, wherein heating the cylinder liner comprises induction heating the cylinder liner.

6. The method of claim 5, further comprising positioning an induction heater within the cylinder bore before induction heating the cylinder liner.

7. The method of claim 1, wherein the bonding substrate comprises an alloy of at least one of Zinc, Aluminum, Iron, Nickel, and Copper.

8. The method of claim 1, wherein the cylinder liner comprises a steel alloy and wherein the engine block comprises an aluminum alloy.

9. The method of claim 1, wherein the cylinder liner comprises an iron alloy and wherein the engine block comprises an aluminum alloy.

10. The method of claim 1, wherein the bonding substrate comprises a filler material having a lower melting temperature than the cylinder liner and the engine block and wherein heating the cylinder liner causes the filler material to melt and form a metallurgical bond between the cylinder liner and the engine block in a brazing operation.

11. The method of claim 1, wherein positioning the cylinder liner comprises pressing the cylinder liner in place within the cylinder bore.

12. The method of claim 1, further comprising machining an internal surface of the cylinder liner.

13. The method of claim 12, wherein the machining comprises honing an internal surface of the cylinder liner.

14. A vehicle engine block prepared by a process comprising the steps of:
providing a bonding substrate on one of an outside surface of a cylinder liner and an inside surface of a cylinder bore in the engine block;
positioning the cylinder liner in the cylinder bore; and
heating the cylinder liner.

15. The vehicle engine block of claim 14, wherein the vehicle engine block comprises an intermetallic material between the outer surface of the cylinder liner and the inside surface of the cylinder bore.

16. The vehicle engine block of claim 14, wherein the cylinder liner comprises a steel alloy, the engine block comprises an Aluminum alloy, and the bonding substrate comprises a filler alloy that forms an intermetallic material between the cylinder liner and the engine block.

17. The vehicle engine block of claim 16, wherein the bonding substrate comprises one of an Iron-Aluminum-Zinc alloy and an Iron-Zinc alloy.

18. The vehicle engine block of claim 16, wherein the intermetallic material comprises at least one of Fe₂Al₅ and FeAl₂.

19. The vehicle engine block of claim 14, wherein the cylinder liner comprises an Iron alloy, the engine block comprises an Aluminum alloy, and the bonding substrate comprises a filler alloy that forms an intermetallic material between the cylinder liner and the engine block.

20. The vehicle engine block of claim 19, wherein the bonding substrate comprises one of an Iron-Aluminum-Zinc alloy and an Iron-Zinc alloy.
